(19) United States
(12) Patent Application Publication
(10) Pub. No.: US 2022/0105467 A1
(43) Pub. Date: Apr. 7, 2022

(54) PRECIPITATION SYSTEM AND PRECIPITATION METHOD

(71) Applicant: TOYOBO CO., LTD., Osaka-shi, Osaka (JP)

(72) Inventors: Daiki Kohno, Osaka-shi, Osaka (JP); Yoji Abe, Osaka-shi, Osaka (JP)

(73) Assignee: TOYOBO CO., LTD., Osaka-shi, Osaka (JP)

(21) Appl. No.: 17/426,335

(22) PCT Filed: Jan. 17, 2020
(86) PCT No.: PCT/JP2020/001505

§ 371 Date: Jul. 28, 2021

(30) Foreign Application Priority Data
Jan. 30, 2019 (JP) 2019-014379

(51) Int. Cl. B01D 61/02; B01D 61/04; B01D 61/08; B01D 69/08; B01D 9/00; C02F 1/44; C02F 1/22

(52) U.S. Cl. CPC B01D 61/022; B01D 61/025; B01D 61/04; B01D 61/08; B01D 69/08; B01D 9/0004; C02F 2001/5218; C02F 1/22; B01D 9/0045; B01D 2317/02; B01D 2311/04; B01D 2311/08; B01D 2311/2642; C02F 1/441

(57) ABSTRACT

A precipitation system for precipitating the target component is provided. The precipitation system includes: a reverse osmosis module; a precipitation device; a membrane separation device that includes a semipermeable membrane module including a first chamber and a second chamber separated by a semipermeable membrane, and that makes the feed solution after precipitation of the target component in the precipitation device flow to each of the first chamber and the second chamber and pressurizes the feed solution in the first chamber to transfer water into the second chamber via the semipermeable membrane and thereby concentrate the feed solution in the first chamber and dilute the feed solution in the second chamber; first return means for returning the feed solution concentrated in the membrane separation device to the precipitation device; and second return means for returning the feed solution diluted in the membrane separation device to the reverse osmosis module.

### TECHNICAL FIELD

The present invention relates to a precipitation system and a precipitation method.

### BACKGROUND ART

Conventionally, devices that precipitate and recover a target component in a feed solution (treatment subject solution) have been known. For example, a system in which a feed solution is cooled and solubility of a target component in water is thereby lowered to precipitate (crystallize) an excess amount of the target component over a saturated concentration and recover the excess amount of the target component as a solid has been known.

On the other hand, as concentration devices for concentration of a component in a feed solution, RO devices using a reverse osmosis (RO)method have been known.

For example, a feed solution is supplied to one side of an RO membrane (two chambers), which is a semipermeable membrane, in an RO module separated in the two chambers by the RO membrane, with supply pressure equal to or exceeding osmotic pressure of a target component to make only water in the feed solution permeate to the other side of the semipermeable membrane via the RO membrane, enabling concentration of the target component in the feed solution.

Patent Literature 1 (Japanese Patent Laying-Open No. 2013-43860) discloses a precipitation system in which a solution containing calcium lactate concentrated by an RO device is cooled to crystalize (precipitate) the calcium lactate and the calcium lactate is removed. In this system, a supernatant liquid in a crystallization device is further concentrated in the RO device and the concentrated liquid is returned to the crystallization device, enhancing efficiency of precipitation of the target component.

### CITATION LIST

### Patent Literature

PTL 1: Japanese Patent Laying-Open No. 2013-43860

### SUMMARY OF INVENTION

### Technical Problem

Like RO, in a case where a feed solution having osmotic pressure is supplied only to one side (high-pressure side) of a semipermeable membrane, on which the feed solution is pressurized, since there is basically only water having no osmotic pressure on the other side of the semipermeable membrane, a difference in osmotic pressure between the opposite sides of the semipermeable membrane is large, and it is necessary to pressurize the feed solution with pressure that is high enough to overcome pressure generated by the osmotic pressure difference. However, the pressure of the pressurization is limited by an operating pressure (limit pressure) of the semipermeable membrane (RO membrane) and/or a maximum pressure of a pump used. Therefore, in RO, the feed solution cannot be concentrated to a high concentration at which the osmotic pressure of the feed solution exceeds. e.g., the operating pressure of the RO membrane and/or the maximum pressure of the pump.

In the system disclosed in Patent Literature 1, the supernatant liquid in the precipitation device is a saturated concentration solution and is highly likely to be a relatively-high concentration solution. In such case, a concentration factor of concentration of the supernatant liquid by the RO device is low, and thus, even if the supernatant liquid concentrated by the RO device is returned to the precipitation device, an amount of the target component precipitated from the returned liquid is small, and conceivably, the precipitation efficiency cannot be enhanced so much. In particular, in the system disclosed in Patent Literature 1, if the osmotic pressure of the supernatant liquid exceeds, e.g., an operating pressure of an RO membrane and/or a maximum pressure of a pump, concentration of the supernatant liquid by the RO device is conceivably impossible in principle.

Therefore, an object of the present invention is to provide a precipitation system and a precipitation method that enable enhancement in efficiency of precipitation of a target component in a feed solution.

### Solution to Problem

(1) A precipitation system for, from a feed solution in which at least one type of target component is dissolved in water, precipitating the target component, the precipitation system including:

a reverse osmosis module that separates water from the feed solution, pressure of the feed solution being raised to a predetermined pressure, via a reverse osmosis membrane to concentrate the feed solution;

a precipitation device that cools the feed solution concentrated in the reverse osmosis module to a stipulated temperature to precipitate the target component;

a membrane separation device that includes a semipermeable membrane module including a semipermeable membrane, and a first chamber and a second chamber separated by the semipermeable membrane, and that makes the feed solution after precipitation of the target component in the precipitation device flow to each of the first chamber and the second chamber and pressurizes the feed solution in the first chamber so that pressure of the feed solution in the first chamber becomes higher than pressure of the feed solution in the second chamber to transfer water contained in the feed solution in the first chamber into the second chamber via the semipermeable membrane and thereby concentrate the feed solution in the first chamber and dilute the feed solution in the second chamber;

first return means for returning the feed solution concentrated in the first chamber of the semipermeable membrane module in the membrane separation device to the precipitation device; and

second return means for returning the feed solution diluted in the second chamber of the semipermeable membrane module in the membrane separation device to the reverse osmosis module.

(2) The precipitation system according to (1), wherein the feed solution after precipitation of the target component in the precipitation device is supplied to the membrane separation device after the feed solution is heated.

(3) The precipitation system according to (1) or (2), wherein:

the feed solution contains a concentration component that is a component other than the target component; and

the target component precipitates, and the concentration component is concentrated.

(4) The precipitation system according to (3), wherein if a concentration of the concentration component in the feed solution becomes equal to or exceeds a normal concentration, a part of the feed solution is recovered

(5) The precipitation system according to any of (1) to (4), wherein a precipitate containing the target component precipitated in the precipitation device is recovered after the precipitate is rinsed using a part of the feed solution, water discharged from the second chamber of the reverse osmosis module or the feed solution diluted in the second chamber of the semipermeable membrane module as a rinse liquid to an extent that the target component is not dissolved.

(6) The precipitation system according to (5), including third return means for returning the rinse liquid after use for the rinsing to the reverse osmosis module.

(7) The precipitation system according to any of (1) to (6), wherein the semipermeable membrane of the semipermeable membrane module is a hollow fiber membrane.

(8) The precipitation system according to (7), wherein in the semipermeable membrane module, a space on an outer side of the hollow fiber membrane is the first chamber and a space on an inner side of the hollow fiber membrane is the second chamber.

(9) The precipitation system according to any of (1) to (8), wherein: the membrane separation device is a multi-stage membrane separation device including a plurality of semipermeable membrane modules each including the semipermeable membrane module;

the plurality of semipermeable membrane modules are connected in series in a flow direction of the first chamber;

the plurality of semipermeable membrane modules include a final module that is the semipermeable membrane module located on a downstream-most side in the flow direction of the first chamber, and at least one upstream module that is the semipermeable membrane module other than the final module; and

the feed solution flows through the first chamber of the upstream module, a part of the feed solution that has flowed through the first chamber of the upstream module flows through the first chamber of the final module, another part of the feed solution flows through the second chamber of the final module, and the feed solution that has flowed through the second chamber of the final module flows through the second chamber of the upstream module.

(10) A precipitation method for, from a feed solution in which at least one type of target component is dissolved in water, precipitating the target component, the precipitation method including:

a reverse osmosis step of separating water from the feed solution, pressure of the feed solution being raised to a predetermined pressure, via a reverse osmosis membrane to concentrate the feed solution;

a precipitation step of cooling the feed solution concentrated in the reverse osmosis step to a stipulated temperature to precipitate the target component;

a membrane separation step of, using a semipermeable membrane module including a semipermeable membrane, and a first chamber and a second chamber separated by the semipermeable membrane, making the feed solution after precipitation of the target component in the precipitation step flow to each of the first chamber and the second chamber and pressurizing the feed solution in the first chamber so that pressure of the feed solution in the first chamber becomes higher than pressure of the feed solution in the second chamber to transfer water contained in the feed solution in the first chamber into the second chamber via the semipermeable membrane and thereby concentrate the feed solution in the first chamber and dilute the feed solution in the second chamber;

a first return step of returning the feed solution concentrated in the first chamber of the semipermeable membrane module in the membrane separation step to the precipitation step; and

a second return step of returning the feed solution diluted in the second chamber of the semipermeable membrane module in the membrane separation step to the reverse osmosis step.

### Advantageous Effects of Invention

The present invention enables provision of a precipitation system and a precipitation method that enable enhancement in efficiency of precipitation of a target component in a feed solution.

### BRIEF DESCRIPTION OF DRAWINGS

FIG. 1 is a schematic diagram illustrating a precipitation system of Embodiment 1.

FIG. 2 is a schematic diagram illustrating an alteration of the precipitation system of Embodiment 1.

FIG. 3 is a schematic diagram illustrating an example of a membrane separation device in Embodiment 1.

FIG. 4 is a schematic diagram illustrating another example of the membrane separation device in Embodiment 1.

### DESCRIPTION OF EMBODIMENTS

Embodiments of the present invention will be described below with reference to the drawings. In the drawings, reference signs that are the same denote respective parts that are identical or correspond to each other. Also, dimensional relationships in, e.g., length, width, thickness and depth are appropriately changed for clarification and simplification of the drawings and thus do not represent actual dimensional relationships.

### Embodiment 1

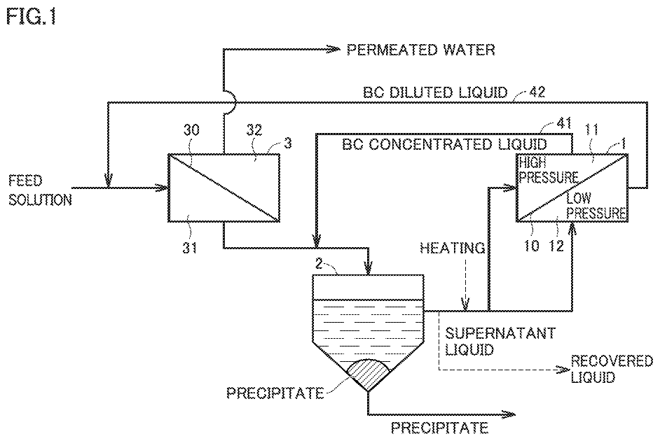

FIG. 1 is a schematic diagram illustrating a precipitation system of Embodiment 1. With reference to FIG. 1, the precipitation system of the present embodiment is a precipitation system for, from a feed solution in which at least one type of target component is dissolved in water, precipitating the target component. The precipitation system includes a reverse osmosis module 3, a precipitation device 2, a membrane separation device including a semipermeable membrane module 1, first return means (first return flow channel) 41, and second return means (second return flow channel) 42.

The feed solution is concentrated by reverse osmosis module 3 (reverse osmosis step). Also in the feed solution, the target component is precipitated from the feed solution by precipitation device 2 (precipitation step). Also, the feed solution is concentrated to a high concentration by the membrane separation device including semipermeable membrane module 1 (membrane separation step: BC). The feed solution concentrated in the membrane separation device (BC concentrated liquid) is returned to the precipitation device by first return means 41. The feed solution diluted in the membrane separation device (BC diluted liquid) is returned to the reverse osmosis module by second return means 42.

As necessary, at least one step of the reverse osmosis step, the precipitation step and the membrane separation step may be repeated. For example, at least one step of the reverse osmosis step, the precipitation step and the membrane separation step may be repeated until a desired amount of the target component is precipitated. Note that in a case where a plurality of steps of the reverse osmosis step, the precipitation step and the membrane separation step are repeated, for example, the steps may be repeated in series, or after one type of step being continuously repeated, another step may be continuously repeated.

(Feed Solution)

The feed solution is a solution in which at least one type of target component is dissolved in water. The target component is a component that can be precipitated by being cooled to a stipulated temperature of the feed solution (lowering a temperature of the feed solution). The target component is preferably an inorganic salt, more preferably a metallic salt.

Specific examples of the target component include. e.g., potassium azide, lithium azide, potassium nitrite, barium nitrite, sodium nitrite, lithium nitrite, ammonium sulfite, potassium benzoate, zinc chloride, ammonium chloride, potassium chloride, calcium chloride, cobalt(II) chloride, mercury(II) chloride, strontium chloride, cesium chloride, iron(II) chloride, copper(II) chloride, nickel(II) chloride, neodymium(III) chloride, barium chloride, manganese(II) chloride, lithium chloride, rubidium chloride, cadmium chlorate, potassium chlorate, silver chlorate, cobalt(II) chlorate, cesium chlorate, sodium chlorate, nickel(II) chlorate, magnesium chlorate, barium chlorate, lithium chlorate, rubidium chlorate, ammonium perchlorate, cadmium perchlorate, silver perchlorate, thallium(I) perchlorate, sodium perchlorate, nickel(II) perchlorate, lithium perchlorate, potassium permanganate, sodium periodate, cadmium formate, potassium formate, strontium formate, sodium formate, lithium formate, rubidium formate, ammonium chromate, potassium chromate, sodium chromate, rubidium chromate, arsenic pentoxide, potassium acetate, sodium acetate, lead(II) acetate, barium acetate, magnesium acetate, lithium acetate, ammonium bromide, calcium bromide, cadmium bromide, potassium bromide, strontium bromide, iron(II) bromide, copper(II) bromide, sodium bromide, nickel(I) bromide, barium bromide, magnesium bromide, manganese(II) bromide, lithium bromide, rubidium bromide, oxalic acid, potassium oxalate, gadolinium(III) bromate, potassium bromate, samarium bromate, terbium bromate, sodium bromate, neodymium(I) bromate, praseodymium(I) bromate, lithium bromate, ammonium tartrate, aluminum nitrate, ammonium nitrate, yttrium(III) nitrate, uranyl nitrate, potassium nitrate, calcium nitrate tetrahydrate, silver nitrate, cobalt(II) nitrate, strontium nitrate, cesium nitrate, thallium(I) nitrate, copper(II) nitrate, sodium nitrate, lead(II) nitrate, barium nitrate, beryllium nitrate, magnesium nitrate, lithium nitrate, rubidium nitrate, potassium hydroxide, thallium(I) hydroxide, sodium hydroxide, barium hydroxide, sucrose, ammonium selenate, potassium selenate, copper(II) selenate, sodium selenate, magnesium selenate, potassium carbonate, ammonium hydrogen carbonate, potassium hydrogen carbonate, sodium carbonate, ammonium thiocyanate, potassium thiocyanate, ammonium dichromate, potassium dichromate, sodium dichromate, potassium ferricyanide, potassium ferrocyanide, potassium fluoride, silver fluoride, ammonium hexafluorosilicate, copper(II) hexafluorosilicate, ammonium iodide, potassium iodide, cesium iodide, sodium iodide, nickel(II)iodide, lithium iodide, potassium iodate, sodium iodate, barium sulfide, zinc sulfate, aluminum sulfate, aluminum ammonium sulfate dodecahydrate, ammonium sulfate, potassium sulfate, cobalt(II) sulfate, cesium sulfate, iron(II) sulfate heptahydrate, copper(II) sulfate pentahydrate, sodium sulfate, lithium sulfate, magnesium sulfate, rubidium sulfate, potassium phosphate, trisodium phosphate, ammonium hydrogen phosphate, ammonium dihydrogen phosphate, sodium dihydrogen phosphate and potassium dihydrogen phosphate. A difference in solubility between 10° C. and 40° C. of each of these target components is no less than 5 mass %.

The target component is preferably a potassium salt or a sodium salt. If the target component is a potassium salt, the potassium salt is preferably potassium sulfate. If the target component is a sodium salt, the sodium salt is preferably sodium sulfate.

The feed solution may contain components other than the target component above.

Examples of the target component other than the inorganic salts include, e.g., sugars such as sucrose and amino acids such as sodium glutamate.

(Reverse Osmosis Module)

Reverse osmosis module 3 is a device that concentrates a feed solution by separating water from the feed solution having pressure raised to a predetermined pressure, via a reverse osmosis membrane 30. Reverse osmosis module 3 is not specifically limited and various known reverse osmosis modules can be used for reverse osmosis module 3.

For example, a liquid mixture of the initial feed solution and the feed solution diluted in the membrane separation device (semipermeable membrane module 1) and returned by second return means 42 (BC diluted liquid) is supplied to a first chamber 31 of reverse osmosis module 3, with pressure of the liquid mixture raised to a predetermined pressure. Consequently, water in the feed solution in first chamber 31 permeates to a second chamber 32 side via the semipermeable membrane. Note that the initial feed solution is a feed solution before being mixed with the BC diluted liquid.

In the precipitation system of the present embodiment, it is conceivable that the target component is precipitated from the feed solution by repeating concentration (BC) using the membrane separation device and precipitation using the precipitation device without using RO module 3. However, in this case, the feed solution diluted by the membrane separation device (BC diluted liquid) is disposed of, and thus, the target component and a concentration component (see Embodiment 2) cannot be recovered from that amount of feed solution, recovery ratios of the target component and the concentration component are decreased by that amount. Therefore, like the precipitation device of the present embodiment, reverse osmosis module 3 is used in combination and the feed solution diluted in the membrane separation device (semipermeable membrane module 1) (BC diluted liquid) is returned to first chamber 31 of reverse osmosis module 3 by second return means 42, enabling enhancement in recovery ratio of the target component and the concentration component.

(Precipitation Device)

Precipitation device 2 is a device that cools a liquid mixture of the feed solution concentrated in reverse osmosis module 3 and a later-described BC concentrated liquid to a stipulated temperature to precipitate the target component. Here, the stipulated temperature is set to a temperature at which the target component precipitates. As necessary, the precipitated target component may be recovered or removed.

(Membrane Separation Device)

The membrane separation device includes semipermeable membrane module 1 including a semipermeable membrane 10, and a first chamber 11 and a second chamber 12 separated by semipermeable membrane 10.

The membrane separation device makes the feed solution after the precipitation of the target component in precipitation device 2 (supernatant liquid) flow to each of first chamber 11 and second chamber 12 and pressurizes the feed solution in first chamber 11 so that pressure of the feed solution in first chamber 11 becomes higher than pressure of the feed solution in second chamber 12 to transfer water contained in the feed solution in first chamber 11 into second chamber 12 via semipermeable membrane 10, enabling concentration of the feed solution in first chamber 11 and dilution of the feed solution in second chamber 12. Consequently, the feed solution can be concentrated to a high concentration enough for osmotic pressure of the feed solution to exceed, e.g., an operating pressure of the semipermeable membrane and/or a maximum pressure of a pump.

Such membrane separation device (membrane separation step: BC) is disclosed in, for example, Japanese Patent Laying-Open No. 2018-65114, as a membrane separation method that needs smaller energy than that of the RO method (brine concentration) (hereinafter may be abbreviated as “BC”).

In BC, a feed solution is made to flow also to the other side (low-pressure side) of a semipermeable membrane to reduce a difference in osmotic pressure between the opposite sides of the semipermeable membrane, enabling reduction of pressure for pressurization of the high pressure-side feed solution. Therefore, use of BC enables the feed solution to be concentrated to a high concentration enough for osmotic pressure of the feed solution to exceed, e.g., the operating pressure of the semipermeable membrane and/or the maximum pressure of the pump.

Therefore, even if a supernatant liquid (saturated concentration solution) in the precipitation device is a high-concentration solution (in particular, if osmotic pressure of the supernatant liquid exceeds, e.g., the operating pressure of the RO membrane and/or the maximum pressure of the pump), the supernatant liquid can be concentrated with a high concentration factor, enabling provision of a BC concentrated liquid with a high concentration. By the BC concentrated liquid being returned to the precipitation device, the target component can be precipitated again from the feed solution.

Note that in BC, if the feed solution is concentrated until the dissolved component reaches a saturated concentration, e.g., clogging of the semipermeable membrane occurs due to precipitation of the component that has reached the saturated concentration. Therefore, in BC, normally, the feed solution can be concentrated up to a concentration that is slightly lower than the saturated concentration.

In precipitation device 2, it is preferable that the feed solution after the precipitation of the target component (supernatant liquid) be supplied to the membrane separation device (semipermeable membrane module 1) after the feed solution is heated. Since the supernatant liquid in precipitation device 2 is a saturated solution, if a temperature of the supernatant liquid is left as it is, precipitation occurs in semipermeable membrane module 1 as a result of the supernatant liquid being concentrated in the membrane separation device, resulting in occurrence of a problem such as clogging of semipermeable membrane 10. By the supernatant liquid being heated to raise the temperature, the solubility of the target component increases, enabling prevention of precipitation when the supernatant liquid is concentrated in the membrane separation device.

Examples of heating means for the heating include, e.g., an electric heater and a heat exchange-type heater. For enhancement in heating efficiency, the supernatant liquid may be heated by the heating means after heat exchange with the BC concentrated liquid via a heat exchanger.

(Semipermeable Membrane Module)

In semipermeable membrane module 1, examples of semipermeable membrane 10 include semipermeable membranes called a reverse osmosis membrane (RO membrane), a forward osmosis membrane (FO membrane), a nanofiltration membrane (NF membrane) and an ultrafiltration membrane (UF membrane). The semipermeable membrane is preferably a reverse osmosis membrane, a forward osmosis membrane or a nanofiltration membrane, more preferably a reverse osmosis membrane or a forward osmosis membrane. If a reverse osmosis membrane, a forward osmosis membrane or a nanofiltration membrane is used as the semipermeable membrane, the pressure of the feed solution in first chamber 11 is preferably 0.5 to 10.0 MPa.

Normally, pore diameters of an RO membrane and an FO membrane are approximately 2 nm or less and a pore diameter of a UF membrane is approximately 2 to 100 nm. An NF membrane has a relatively low rate of blocking ions and salts from among RO membranes, and normally, a pore diameter of an NF membrane is approximately 1 to 2 nm. If an RO membrane, an FO membrane or an NF membrane is used as the semipermeable membrane, a salt removal rate of the RO membrane, the FO membrane or the NF membrane is preferably no less than 90%.

A material forming the semipermeable membrane is not specifically limited, and examples of the material include, e.g., a cellulose-based resin, a polysulfone-based resin and a polyamide-based resin. It is preferable that the semipermeable membrane be formed of a material containing at least any of a cellulose-based resin and a polysulfone-based resin.

The cellulose-based resin is preferably a cellulose acetate-based resin. A cellulose acetate-based resin has tolerance for chlorine, which is a disinfection agent, and has a characteristic of being capable of curbing proliferation of microorganism The cellulose acetate-based resin is preferably cellulose acetate, and from the perspective of durability, more preferably cellulose triacetate.

The polysulfone-based resin is preferably a polyether sulfone-based resin. The polyether sulfone-based resin is preferably sulfonated polyether sulfone.

A shape of semipermeable membrane 10 is not specifically limited, and examples of semipermeable membrane 10 include a flat membrane, a spiral membrane and a hollow fiber membrane. Although in FIG. 1, a flat membrane is drawn in a simplified manner as semipermeable membrane 10, the shape of semipermeable membrane 10 is not limited to such shape and semipermeable membrane 10 is preferably a hollow fiber membrane. A hollow fiber membrane (hollow fiber-type semipermeable membrane) is advantageous in having a small thickness, enabling an increase in membrane area per module and thus enabling enhancement in permeation efficiency in comparison with, e.g., a spiral semipermeable membrane. In this case, it is preferable that: the semipermeable membrane module includes a plurality of hollow fiber membranes; and each of the plurality of hollow fiber membranes include an opening portion at each of opposite ends thereof.

If semipermeable membrane 10 is a hollow fiber membrane, it is preferable that first chamber 11 be on the outer side of the hollow fiber membrane; and second chamber 12 be on the inner side of the hollow fiber membrane. It is preferable that a solution on the outer side of the hollow fiber membrane be pressurized. This is because: even if a solution flowing inside (hollow portion) the hollow fiber membrane is pressurized, the pressurization may fail to be sufficiently performed because of large pressure loss; and a structure of the hollow fiber membrane itself can easily be held against outer pressure but the membrane may rupture upon provision of high inner pressure. However, if a hollow fiber membrane having small pressure loss, that is, having a large inner diameter and a high resistance against inner pressure is used, there is no problem in first chamber 11 being on the inside of the hollow fiber membrane.

Also, like semipermeable membrane 10 of semipermeable membrane module 1, reverse osmosis membrane 30 of reverse osmosis module 3 described above may be a hollow fiber membrane.

(First Return Means and Second Return Means)

The precipitation system of the present embodiment further includes the first return means and the second return means.

The first return means is means (e.g., a flow channel) for returning the feed solution concentrated in the first chamber of the semipermeable membrane module in the membrane separation device (BC concentrated liquid) to the precipitation device (that is, supplying a liquid mixture of the BC concentrated liquid and the feed solution concentrated in RO module 3 to precipitation device 2).

The second return means is means (e.g., a flow channel) for returning the feed solution diluted in the second chamber of the semipermeable membrane module in the membrane separation device (BC diluted liquid) to RO module 3 (that is, supplying the liquid mixture of the BC diluted liquid and the initial feed solution to first chamber 31 of RO module 3).

In the present embodiment, as a result of the precipitation system including first return means 41 for returning the BC concentrated liquid to precipitation device 2, concentration and precipitation of the target component by the membrane separation device (semipermeable membrane module 1) and precipitation device 2 can be repeated, enabling precipitation of a desired amount of target component from the feed solution.

Furthermore, as a result of the precipitation system including second return means 42 for returning the BC diluted liquid to RO module 3, the BC diluted liquid can be concentrated in RO module 3 and provided for precipitation in precipitation device 2 without being discharged, enabling enhancement in efficiency of precipitation (recovery ratio) of the target component from the feed solution.

(Alteration)

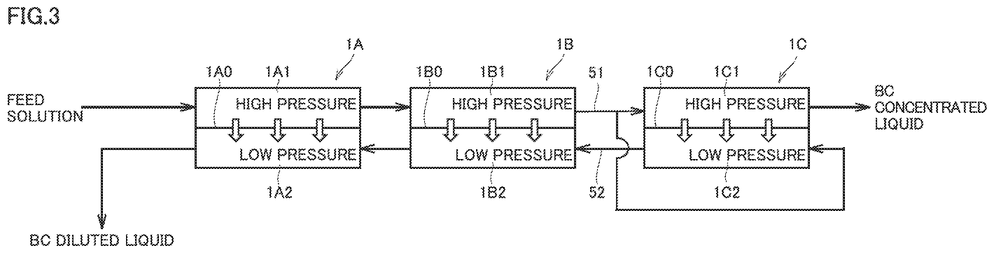

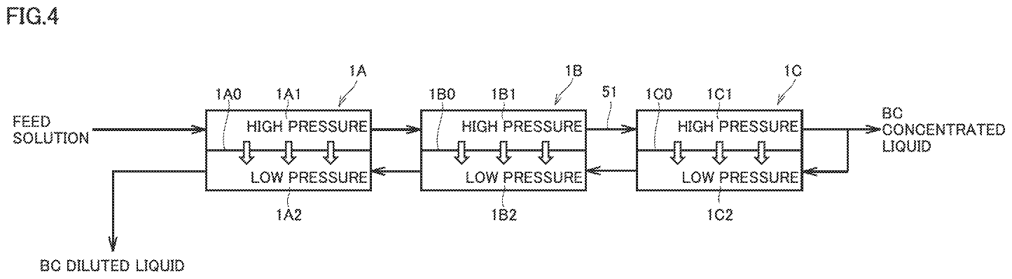

FIG. 3 is a schematic diagram illustrating an example of the membrane separation device in Embodiment 1. FIG. 4 is a schematic diagram illustrating another example of the membrane separation device in Embodiment 1. The present alteration is different from Embodiment 1 in providing a multi-stage device using a plurality of semipermeable membrane modules 1 such as that illustrated in FIG. 3 or 4 instead of a single-stage membrane separation device using a single semipermeable membrane module 1 such as that illustrated in FIG. 1. The present alterations are similar to Embodiment 1 for the rest.

With reference to FIGS. 3 and 4, in an example of the present alteration, a membrane separation device is a multi-stage membrane separation device using a plurality of semipermeable membrane modules 1A, 1B, 1C each formed of the above-described semipermeable membrane module.

The plurality of semipermeable membrane modules 1A, 1B, 1C are connected in series in a flow direction of first chambers 1A1, 1B1, 1C1; and

the plurality of semipermeable membrane modules 1A, 1B, 1C include final module 1C that is a semipermeable membrane module located on the downstream-most side in the flow direction of first chambers 1A1, 1B1, 1C1, and at least one upstream module 1A, 1B that is a semipermeable membrane module other than the final module.

Then, as illustrated in FIG. 3, it is preferable that a feed solution flow through first chambers 1A1, 1B1 of upstream modules 1A, 1B, a part of a feed solution 51 that has flowed through first chamber 1B1 of upstream module 1B flow through first chamber 1C1 of final module 1C, another part of feed solution 51 flow through a second chamber 1C2 of final module 1C, and a feed solution 52 that has flowed through second chamber 1C2 of final module 1C flow through second chambers 1B2, 1A2 of upstream modules 1B, 1A, or

as illustrated in FIG. 4, a feed solution flow through first chambers 1A1, 1B1 of upstream modules 1A, 1B, feed solution 51 that has flowed through first chamber 1B1 of upstream module 1B flow through first chamber 1C1 of final module 1C, a part of the concentrated liquid in final module 1C flow through second chamber 1C2 of final module 1C and flow through second chambers 1B2, 1A2 of upstream modules 1B, 1A.

Note that in a multi-stage membrane separation device, in a case where a plurality of semipermeable membrane modules are connected in series and a feed solution is made to flow in a direction that is the same between the first chamber side and the second chamber side, a difference in osmotic pressure of the liquid between opposite sides (the first chamber and the second chamber) of a semipermeable membrane is small in the semipermeable membrane module on the upstream side, but the difference in osmotic pressure of the liquid between the opposite sides of the semipermeable membrane gradually becomes larger in the semipermeable membrane module further on the downstream side. Therefore, it is necessary to apply a pressure that overcomes the osmotic pressure to the feed solution of the first chamber. On the other hand, in a multi-stage membrane separation device such as that illustrated in FIG. 3 (the present alteration), a difference in osmotic pressure of the liquid between the opposite sides of a semipermeable membrane is reduced in each of the semipermeable membrane modules on the upstream side and the downstream side, and thus, there is an advantage of enabling reduction of pressure needed to be applied to the feed solution in the first chamber.

Also, in a multi-stage membrane separation device such as that illustrated in FIG. 3, from a feed solution, only the feed solution finally concentrated to a high concentration (BC concentrated liquid) that flows out from first chamber 1C1 of final module 1C and the feed solution finally diluted (BC diluted liquid) that flows out from second chamber 1A2 of upstream module 1A on the upstream-most side are obtained. Therefore, each time a feed solution is concentrated to a high concentration by the membrane separation device, generation of a plurality of diluted liquids having different concentrations is curbed. Consequently, concentration of a feed solution (supernatant liquid in a precipitation device) can be performed with a simple membrane separation device (membrane separation step: BC).

### Embodiment 2

A precipitation system of the present embodiment is a precipitation system having a basic configuration that is similar to that of Embodiment 1 illustrated in FIG. 1.

In the present embodiment, a feed solution contains a concentration component as a component other than a target component. The concentration component is a component that can be concentrated by the precipitation system (precipitation method) of the present embodiment. In other words, the precipitation system (precipitation method) of the present embodiment enables precipitation of a target component in a feed solution and concentration of a concentration component that is another component in the feed solution.

In the present embodiment, it is preferable that the target component be a component that upon the feed solution being cooled, precipitates prior to the concentration component. Also, it is preferable that solubility of the target component be lower than that of the concentration component.

In the present embodiment, the feed solution contains the concentration component in addition to the target component, and a stipulated temperature is set to a temperature at which the target component precipitates and the concentration component does not precipitate or an amount of concentration component precipitated is smaller than an amount of target component precipitated.

Consequently, a concentration of the target component in the feed liquid is lowered, enabling the concentration component to be concentrated with a concentration factor that is higher than that of the target component. In other words, it is possible to selectively concentrate the concentration component in the feed solution.

In the present embodiment, it is preferable that, in a case where a concentration of the concentration component in the feed solution becomes equal to or exceeds a normal concentration, a part of the feed solution is recovered. Consequently, it is possible to recover a liquid containing the concentration component with a high concentration. The recovered feed solution may be, for example, the feed solution after precipitation of the target component in a precipitation device 2 (supernatant liquid) or the feed solution concentrated in a first chamber 11 of a semipermeable membrane module 1 in a membrane separation device (BC concentrated liquid).

Here, since a purity of the concentration component is higher in the supernatant liquid after precipitation of the target component than in the BC concentrated liquid, it is preferable that the recovered feed solution be the supernatant liquid.

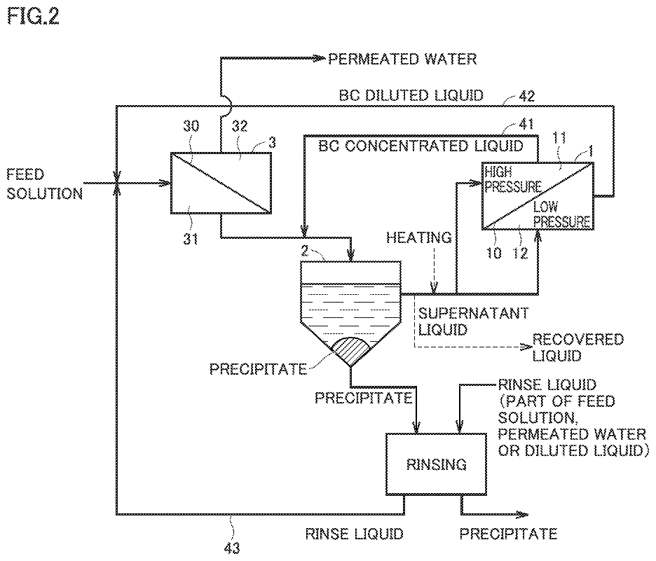

Also, as illustrated in FIG. 2, it is preferable that a precipitate containing the target component precipitated in the precipitation device be recovered after the precipitate is rinsed using a part of the feed solution, permeated water (water discharged from a second chamber 32 of an RO module 3) or a BC diluted liquid (the feed solution diluted in a second chamber 12 of semipermeable membrane module 1) as a rinse liquid to the extent that the target component is not dissolved. In this case, it is preferable that third return means (third return flow channel) 43 for returning the rinse liquid after use for rinsing to a reverse osmosis module be provided. A liquid containing the concentration component adheres to the precipitate precipitated in precipitation device 2 and the concentration component transfers to the rinse liquid via rinsing, and thus, the concentration component can be recovered again, enabling further enhancement in recovery ratio of the concentration component.

Examples of a specific method for the rinsing include a method in which the precipitate is brought into contact with the rinse liquid and then the precipitate and the rinse liquid are separated from each other. Examples of a method for bringing the precipitate into contact with the rinse liquid include a method in which the rinse liquid is added into a container that receives the precipitate and the precipitate in the rinse liquid is stirred. Example of a method for separating the precipitate and the rinse liquid includes a method in which the precipitate and the rinse liquid are separated from each other via a solid-liquid separation method such as static placement and centrifugation.

In the present embodiment, as a result of the precipitation system including first return means 41, concentration and precipitation of the target component by the membrane separation device (semipermeable membrane module 1) and precipitation device 2 can be repeated and the concentration component in the feed solution can be concentrated with a concentration factor that is higher than that of the target component, enabling selective concentration of the concentration component.

Furthermore, as a result of the precipitation system including second return means 42 for returning the BC diluted liquid to RO module 3, the BC diluted liquid can be concentrated in RO module 3 and be provided to precipitation device 2 without being discharged, enabling enhancement in recovery ratio of the concentration component from the feed solution.

### EXAMPLES

The present invention will be described in more detail below taking examples: however, the present invention is not limited to these examples. Methods for measuring respective characteristics in the examples are as follows.

[1] Measurement of Recovery Ratio of Target Component

A dry weight of a recovered precipitate was measured and a recovery ratio (R) of a target component was calculated according to the following expression.

R(mass %)=(W2/W1)×100

Here, W1 is a dry weight (g) of the target component in an initial feed solution, and W2 is a dry weight (g) of the target component in the precipitate.

[2] Measurement of Concentration Factor of Concentration Component

A concentration of the target component in a recovered liquid (feed solution with a concentration component concentrated to a normal concentration or more) was measured and a concentration factor (M) of the target component was calculated according to the following expression.

M(mass %)=(C2/C1)×100

Here, C1 is a concentration (mass %) of the concentration component in the initial feed solution, and C2 is a concentration (mass %) of the concentration component in the recovered liquid.

[3] Determination of Dry Weight (W1) of Target Component in Initial Feed Solution

The concentration of the target component in the feed solution was measured, and W1 was calculated by the product of a liquid quantity (g) and the concentration (mass %) of the target component.

[4] Determination of dry weight (W2) of target component in precipitate A solution in which the precipitate was completely dissolved in water was prepared, the concentration of the target component in the solution was measured, and W2 was calculated by the product of a total quantity (g) of the solution and the concentration (mass %) of the target component.

[5] Determination of Concentrations of Respective Components in Liquid

Concentrations of cations (potassium ions and lithium ions) and anions (sulfate ions) were measured according to the following method to calculate concentrations of respective components (potassium sulfate and lithium sulfate) in the liquid. In the present examples, as an example, lithium sulfate and potassium sulfate were used. Cation measurement method: ICP-AES (inductively coupled plasma-atomic emission spectrometry)

### Anion Measurement Method: Ion Chromatography

### Example 1

Using a precipitation system such as that illustrated in FIG. 1, precipitation of a target component (potassium sulfate) was performed under the below operation conditions. Here, a membrane separation device is a single-stage membrane separation device including a single semipermeable membrane module 1 such as that illustrated in FIG. 1.

Pressure of a liquid supplied to an RO module 3: 5 MPa

Temperature of the liquid supplied to RO module 3: 30° C.

Reverse osmosis membrane 30 of RO module 3: hollow fiber-type reverse osmosis membrane (material: cellulose triacetate)

Set temperature of a precipitation device 2: 10° C. (stipulated temperature in the present example)

Pressure of a liquid supplied to semipermeable membrane module 1 of the membrane separation device: 6.5 MPa (first chamber) and 0.1 MPa (second chamber) Temperature of the liquid supplied to semipermeable membrane module 1 of the membrane separation device: 40° C.

Semipermeable membrane 10 in semipermeable membrane module 1 of the membrane separation device: hollow fiber-type reverse osmosis membrane (material: cellulose triacetate) (a module that is the same as an RO module was used as the semipermeable membrane module of the membrane separation device)

In the present example, a water solution containing 8 mass % of potassium sulfate as the target component was used as a feed solution.

First, a liquid mixture of the initial feed solution (flow rate: 30 g/min) and the feed solution diluted in a second chamber 12 of the later-described membrane separation device (BC diluted liquid) was supplied to a first chamber 31 of RO module 3, with pressure of 7 MPa and at a flow rate of 50 g/min and was concentrated. Next, a liquid mixture of the feed solution concentrated in RO module 3 and the feed solution concentrated in the first chamber of semipermeable membrane module 1 of the later-described membrane separation device (BC concentrated liquid) was supplied to precipitation device 2 and was cooled. Through this operation, potassium sulfate precipitated (crystallized) from the feed solution, and the solid precipitate was recovered. Next, a supernatant liquid was transported from precipitation device 2 and heated to 40° C., and then, was supplied to first chamber 11 of semipermeable membrane module 1 of the membrane separation device, with pressure of 6.5 MPa and at a flow rate of 48 g/min and was supplied to second chamber 12, with pressure of 0.1 MPa and at a flow rate of 8 g/min.

In the present example, as illustrated in FIG. 1, the concentrated feed solution (BC concentrated liquid) discharged from first chamber 11 of semipermeable membrane module 1 was mixed with the concentrated feed solution in the RO module and supplied to precipitation device 2. Also, the diluted feed solution (BC diluted liquid) discharged from second chamber 12 of semipermeable membrane module 1 was mixed with the initial feed solution and was supplied to first chamber 31 of RO module 3.

After operation for a certain period of time under the above-indicated operation conditions, potassium sulfate concentrations of respective liquids were measured. As a result, the concentration of potassium sulfate in a liquid discharged from a second chamber 32 of RO module 3 (permeated water) was no more than 0.1 mass %, which indicates that water was successfully removed from the feed solution by the RO module. Also, the concentration of potassium sulfate in the supernatant liquid in precipitation device 2 was 8.5 mass %, which is a saturated concentration of potassium sulfate at a cooling temperature (set temperature of precipitation device 2) of 10° C. Also, the concentration of potassium sulfate in the BC concentrated liquid discharged from first chamber 11 of semipermeable membrane module 1 was 13.5 mass %, which indicates that the supernatant liquid was successfully concentrated to such high concentration.

Also, a dry weight of potassium sulfate in the recovered precipitate was measured, and as a result of calculation of a recovery ratio, the recovery ratio was no less than 90 mass %, and potassium sulfate was recovered with high efficiency. In this way, after enhancement in saturated solubility of potassium sulfate by heating the supernatant liquid from precipitation device 2, the supernatant liquid is concentrated to a concentration that is higher than the saturated concentration of potassium sulfate at 10° C. in the membrane separation device (semipermeable membrane module 1) and then returned to precipitation device 2 and cooled, enabling a difference between the concentration of the BC concentrated liquid and the saturated concentration of potassium sulfate at 10° C. (8.5 mass %) to be recovered as a precipitate of potassium sulfate.

### Example 2

In the present example, a water solution containing 8 mass % of potassium sulfate as a target component and further containing 1 mass % of lithium sulfate as a concentration component was used as a feed solution. Using a system that is similar to the precipitation system of Example 1 for the rest, precipitation of the target component (potassium sulfate) and concentration of the concentration component (lithium sulfate) were performed under conditions that are similar to those of Example 1.

After operation for a certain period of time, a part of a supernatant liquid in a precipitation device 2 (flow rate: 19 g/min) was recovered as a recovered liquid.

After further operation for a certain period of time, concentrations of potassium sulfate and lithium sulfate in respective liquids were measured. As a result, the concentration of potassium sulfate and the concentration of lithium sulfate in the liquid discharged from a second chamber 32 of an RO module 3 (permeated water) are both no more than 0.1 mass %, which indicates that water was successfully removed from the feed solution by the RO module.

Also, a recovery ratio of potassium sulfate (ratio of potassium sulfate relative to the total quantity of potassium sulfate contained in the initial feed solution) was 90 mass %, which indicates that potassium sulfate was successfully recovered with high efficiency. Also, the concentration of potassium sulfate in the BC concentrated liquid discharged from a first chamber 11 of a semipermeable membrane module 1 was 12 mass %, enabling a difference between the BC concentrated liquid and the saturated concentration of potassium sulfate at 10° C. (8.5 mass %) to be recovered as a precipitate of potassium sulfate in precipitation device 2.

Also, the concentration of lithium sulfate in the recovered liquid was 7.1 mass %, which indicates that lithium sulfate was successfully concentrated with a high concentration factor of 7.1 times.

### Comparative Example 1

In a semipermeable membrane module 1 of a membrane separation device, no supernatant liquid was supplied to a second chamber 12. After operation for a certain period of time in such a manner as to be similar to Example 1 except the above, concentrations of potassium sulfate in respective liquids were measured. As a result, a recovery ratio of potassium sulfate as a precipitate was no more than 5 mass %, and thus, the recovery ratio of potassium sulfate was low in comparison with Example 1.

This may be because: since osmotic pressure of the feed solution was higher than, e.g., operating pressure of a semipermeable membrane and/or a maximum pressure of a pump, water failed to permeate from the feed solution in a first chamber 11 to second chamber 12 side via the semipermeable membrane and thus the feed solution was not concentrated and the concentration of the feed solution discharged from the membrane separation device was no more than the saturated concentration of potassium sulfate at 10° C. (8.5 mass %), and thus, almost no precipitate was generated in the feed liquid returned from the membrane separation device to a precipitation device.

### Comparative Example 2

In a semipermeable membrane module 1 of a membrane separation device, no supernatant liquid was supplied to a second chamber 12. After operation for a certain period of time in such a manner as to be similar to Example 2 except the above, concentrations of potassium sulfate and lithium sulfate in respective liquids were measured. As a result, a recovery ratio of potassium sulfate as a precipitate was no more than 5 mass %, and thus, the recovery ratio of potassium sulfate was low in comparison with Example 2. A reason for that may be similar to that of Comparative Example 1.

Also, the concentration of lithium sulfate in the recovered liquid was no more than 1.3 mass % and a concentration factor of lithium sulfate was no more than 1.3 times. A reason that the concentration factor of lithium sulfate was lower than that of Example 2 in this way can be considered to be that as almost no concentration of the feed solution occurred in the membrane separation device as with potassium sulfate.

The embodiments disclosed here should be considered as mere examples in all respects and as being not limiting. The scope of the present invention is indicated not by the above description but by the claims, and is intended to include all changes within the meaning and scope equivalent to the claims.

### REFERENCE SIGNS LIST

1 semipermeable membrane module, 1A, 1B upstream module (semipermeable membrane module), 1C final module (semipermeable membrane module), 10, 1A0, 1B0, 1C0 semipermeable membrane, 11, 1A1, 1B1, 1C1 first chamber, 12, 1A2, 1B2, 1C2 second chamber. 2 precipitation device, 3 reverse osmosis (RO) module, 30 reverse osmosis (RO)membrane, 31 first chamber, 32 second chamber, 41 first return means, 42 second return means, 43 third return means, 51, 52 feed solution

1. A precipitation system for, from a feed solution in which at least one type of target component is dissolved in water, precipitating the target component, the precipitation system comprising:
a reverse osmosis module that separates water from the feed solution, pressure of the feed solution being raised to a predetermined pressure, via a reverse osmosis membrane to concentrate the feed solution;
a precipitation device that cools the feed solution concentrated in the reverse osmosis module to a stipulated temperature to precipitate the target component;
a membrane separation device that includes a semipermeable membrane module including a semipermeable membrane, and a first chamber and a second chamber separated by the semipermeable membrane, and that makes the feed solution after precipitation of the target component in the precipitation device flow to each of the first chamber and the second chamber and pressurizes the feed solution in the first chamber so that pressure of the feed solution in the first chamber becomes higher than pressure of the feed solution in the second chamber to transfer water contained in the feed solution in the first chamber into the second chamber via the semipermeable membrane and thereby concentrate the feed solution in the first chamber and dilute the feed solution in the second chamber;
first return means for returning the feed solution concentrated in the first chamber of the semipermeable membrane module in the membrane separation device to the precipitation device; and
second return means for returning the feed solution diluted in the second chamber of the semipermeable membrane module in the membrane separation device to the reverse osmosis module.

2. The precipitation system according to claim 1, wherein the feed solution after precipitation of the target component in the precipitation device is supplied to the membrane separation device after the feed solution is heated.

3. The precipitation system according to claim 1, wherein:
the feed solution contains a concentration component that is a component other than the target component; and
the target component precipitates, and the concentration component is concentrated.

4. The precipitation system according to claim 3, wherein if a concentration of the concentration component in the feed solution becomes equal to or exceeds a normal concentration, a part of the feed solution is recovered.

5. The precipitation system according to claim 1, wherein a precipitate containing the target component precipitated in the precipitation device is recovered after the precipitate is rinsed using a part of the feed solution, water discharged from the reverse osmosis module or the feed solution diluted in the second chamber of the semipermeable membrane module as a rinse liquid to an extent that the target component is not dissolved.

6. The precipitation system according to claim 5, comprising third return means for returning the rinse liquid after use for the rinsing to the reverse osmosis module.

7. The precipitation system according to claim 1, wherein the semipermeable membrane of the semipermeable membrane module is a hollow fiber membrane.

8. The precipitation system according to claim 7, wherein in the semipermeable membrane module, a space on an outer side of the hollow fiber membrane is the first chamber and a space on an inner side of the hollow fiber membrane is the second chamber.

9. The precipitation system according to claim 1, wherein:
the membrane separation device is a multi-stage membrane separation device including a plurality of semipermeable membrane modules each including the semipermeable membrane module;
the plurality of semipermeable membrane modules are connected in series in a flow direction of the first chamber;
the plurality of semipermeable membrane modules include a final module that is the semipermeable membrane module located on a downstream-most side in the flow direction of the first chamber, and at least one upstream module that is the semipermeable membrane module other than the final module; and
the feed solution flows through the first chamber of the upstream module, a part of the feed solution that has flowed through the first chamber of the upstream module flows through the first chamber of the final module, another part of the feed solution flows through the second chamber of the final module, and the feed solution that has flowed through the second chamber of the final module flows through the second chamber of the upstream module.

10. A precipitation method for, from a feed solution in which at least one type of target component is dissolved in water, precipitating the target component, the precipitation method comprising:
a reverse osmosis step of separating water from the feed solution, pressure of the feed solution being raised to a predetermined pressure, via a reverse osmosis membrane to concentrate the feed solution;
a precipitation step of cooling the feed solution concentrated in the reverse osmosis step to a stipulated temperature to precipitate the target component;
a membrane separation step of, using a semipermeable membrane module including a semipermeable membrane, and a first chamber and a second chamber separated by the semipermeable membrane, making the feed solution after precipitation of the target component in the precipitation step flow to each of the first chamber and the second chamber and pressurizing the feed solution in the first chamber so that pressure of the feed solution in the first chamber becomes higher than pressure of the feed solution in the second chamber to transfer water contained in the feed solution in the first chamber into the second chamber via the semipermeable membrane and thereby concentrate the feed solution in the first chamber and dilute the feed solution in the second chamber;
a first return step of returning the feed solution concentrated in the first chamber of the semipermeable membrane module in the membrane separation step to the precipitation step; and
a second return step of returning the feed solution diluted in the second chamber of the semipermeable membrane module in the membrane separation step to the reverse osmosis step.
